(19) United States
(12) Patent Application Publication
(10) Pub. No.: US 2019/0113675 A1
(43) Pub. Date: Apr. 18, 2019

(54) LIGHT SOURCE DEVICE AND DISPLAY DEVICE

(71) Applicant: SAKAI DISPLAY PRODUCTS CORPORATION, Sakai-shi, Osaka (JP)

(72) Inventor: Arimasa SUGIMOTO, Sakai-shi, Osaka (JP)

(73) Assignee: SAKAI DISPLAY PRODUCTS CORPORATION, Sakai-shi, Osaka (JP)

(21) Appl. No.: 16/089,363

(22) PCT Filed: Mar. 28, 2016
(86) PCT No.: PCT/JP2016/059973

§ 371 Date: Sep. 27, 2018

(51) Int. Cl. F21V 8/00; G02F 1/1333

(52) U.S. Cl. CPC G02B 6/0085; G02B 6/0088; G02F 1/133308; G02B 6/0055; G02F 2001/133317; G02F 2001/13332; G02B 6/0068; G02F 2001/133314

(57) ABSTRACT

A light source device provided with a substrate having a mounting surface on which a light source is mounted; a light guide body having a light incident surface on which emitted light from the light source enters, a light emission surface by which light that entered from the light incident surface is emitted, and an opposite facing surface facing the light emission surface; and a support member for supporting the substrate so that the emitted light enters the light guide body from the light incident surface, the light source device characterized in that the mounting surface has a first region that is not directly facing the light incident surface, and a second region that is directly facing the light incident surface; the support member has a surface in contact with the back surface of the mounting surface, and has a holding part for holding the substrate, and a projecting part projecting from the holding part facing toward a region facing opposite the opposite facing surface, with a thermal insulation member interposed between the projecting part and the light guide body; and the thermal insulation member has a first abutting part abutting the first region.

### TECHNICAL FIELD

The present invention relates to a light source device and a display apparatus including a mechanism that releases heat generated by a light source to the outside of the apparatus.

### BACKGROUND ART

A display apparatus including a display panel and an edge-lit light source device is known (see Patent Document No. 1).

An edge-lit light source device includes a substrate having a light source mounted thereon, a support member supporting the substrate, and a light guide body. The substrate is, for example, bonded to the support member with a two-sided tape or attached to the support member by a screw or a rivet. One of end surfaces of the light source body, which is plate-like, is a light incident surface, and a light output surface thereof is arranged to face the display panel. The support member is located such that the light source faces the light incident surface of the light guide body.

Light directed from the light source enters into the light guide body via the light incident surface and is directed outside via the light output surface to illuminate the display panel. Heat generated by the light source at this point is released to the outside of the apparatus from the substrate via the support member.

### CITATION LIST

### Patent Literature

Patent Document No. 1: Japanese Laid-Open Patent Publication No. 2002-156632

### SUMMARY OF INVENTION

### Technical Problem

In the case where, for example, the two-sided tape rises up (is delaminated) due to an error made when the two-sided tape is bonded to secure the substrate and the support member to each other or due to aging, a gap may be made between the substrate and the support member. Or, for example, the screw or the rivet securing the substrate and the support member to each other may be loosened, and in this case also, a gap may be made between the substrate and the support member.

If there is such a gap between the substrate and the support member, the heat is not easily conducted from the substrate to the support member, and thus the heat dissipation efficiency of the support member is declined.

The present invention made in light of such a situation has a main object of providing a light source device and a display apparatus that efficiently releases heat, generated by the light source, to the outside of the apparatus.

### Solution to Problem

A light source device in an embodiment includes a substrate having a mounting surface on which a light source is mounted; a light guide body having a light incident surface via which light directed from the light source enters into the light guide body, a light output surface, via which the light that has entered into the light guide body via the light incident surface, is directed outside, and a facing surface facing the light output surface; and a support member supporting the substrate such that the light directed from the light source enters into the light guide body via the light incident surface. The mounting surface includes a first region not exactly facing the light incident surface and a second region exactly facing the light incident surface. The support member has a surface in contact with a rear surface opposite to the mounting surface, and includes a holding portion holding the substrate and a protrusion protruding from the holding portion toward a region facing the facing surface. A heat-insulating member is provided between the protrusion and the light guide body. The heat-insulating member includes a first contact portion in contact with the first region.

A light source device in an embodiment includes a substrate having a mounting surface on which a light source is mounted; a light guide body having a light incident surface via which light directed from the light source enters into the light guide body, a light output surface, via which the light that has entered into the light guide body via the light incident surface, is directed outside, and a facing surface facing the light output surface; and a support member supporting the substrate such that the light directed from the light source enters into the light guide body via the light incident surface. The mounting surface includes a first region not exactly facing the light incident surface and a second region exactly facing the light incident surface. The support member has a surface in contact with a rear surface opposite to the mounting surface, and includes a holding portion holding the substrate and a protrusion protruding from the holding portion toward a region facing the facing surface. A heat-insulating member is provided between the protrusion and the light guide body. The light source device further includes an interjacent member located between the heat-insulating member and the first region, the interjacent member holding the substrate in a state where the substrate is located between the interjacent member and the support member.

A display apparatus in an embodiment includes the light source device in an embodiment; and a display panel illuminated by the light source device.

### Advantageous Effects of Invention

In the light source device and the display apparatus in the embodiment, when the first contact portion of the heat-insulating member is pressed toward the support member, the substrate is held between the first contact portion of the heat-insulating member and the support member. Alternatively, in the light source device and the display apparatus in the embodiment, the substrate is held between the interjacent member and the support member.

Therefore, the adherence between the substrate and the support member is improved. As a result, heat generated by the light source is conducted efficiently to the support member via the substrate, and the heat is released efficiently to the outside of the apparatus.

### BRIEF DESCRIPTION OF DRAWINGS

FIG. 1 is a cross-sectional view showing a general structure of a part of a display apparatus including a light source device in embodiment 1.

FIG. 2 is a perspective view showing a general structure of a substrate, a support member and a heat-insulating member included in the light source device.

FIG. 3 is a cross-sectional view showing a general structure of a part of a display apparatus including a light source device in embodiment 2.

FIG. 4 is a cross-sectional view showing a general structure of a part of a display apparatus including a light source device in embodiment 3.

FIG. 5 is a perspective view showing a general structure of a substrate, a support member and a heat-insulating member included in the light source device.

FIG. 6 is a cross-sectional view showing a general structure of a part of a display apparatus including a light source device in embodiment 4.

FIG. 7 is a cross-sectional view showing a general structure of a part of a display apparatus including a light source device in embodiment 5.

FIG. 8 is a cross-sectional view showing a general structure of a part of a display apparatus including a light source device in embodiment 6.

FIG. 9 is a cross-sectional view showing a general structure of a part of a display apparatus including a light source device in embodiment 7.

### DESCRIPTION OF EMBODIMENTS

Hereinafter, the present invention will be described in detail with reference to the drawings showing embodiments thereof.

### Embodiment 1

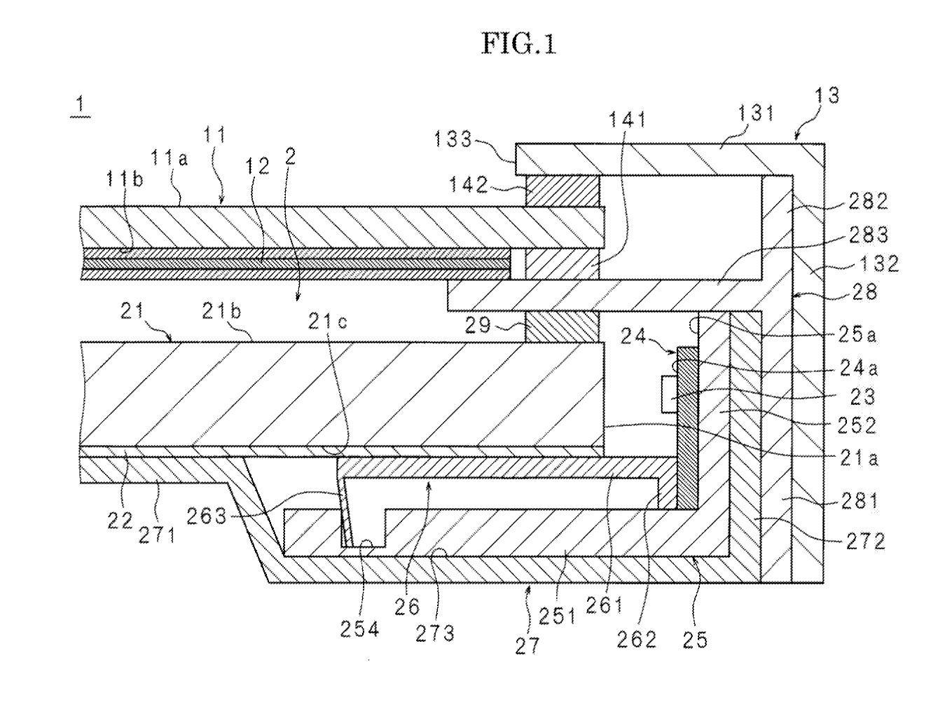

FIG. 1 is a cross-sectional view showing a general structure of a part of a display apparatus including a light source device in embodiment 1.

In the figure, 1 is a display apparatus. The display apparatus 1 includes a display panel 11 and a backlight unit (light source device) 2.

The display panel 11 is a light-transmissive liquid crystal display panel. The display panel 11, which is a rectangular plate, includes a display screen 11a displaying images (encompassing video sequences).

The backlight unit 2 illuminates a rear surface 11b opposite to the display screen 11a. In this specification, two outer surfaces of one same component that are directed in opposite directions to each other will be referred to as a “front surface” and a “rear surface”.

The backlight unit 2 includes a light guide body 21, a reflective sheet 22, light sources 23, a substrate 24, a support member 25, a heat-insulating member 26, a BL (backlight) chassis 27, and a frame body 28.

The light guide body 21, which is rectangular plate-like, is formed of a light-transmissive material, for example, an acrylic resin or glass. One of end surfaces of the light guide body 21 is a light incident surface 21a, and light entering into the light guide body 21 via the light incident surface 21a is directed out of the light guide body 21 via a light output surface 21b. Hereinafter, a surface, of the light guide body 21, that faces the light output surface 21b will be referred to as a “facing surface 21a”.

The reflective sheet 22 has a rectangular light-reflective surface reflecting light. The light-reflective surface of the reflective sheet 22 covers the entirety of the facing surface 21o of the light guide body 21.

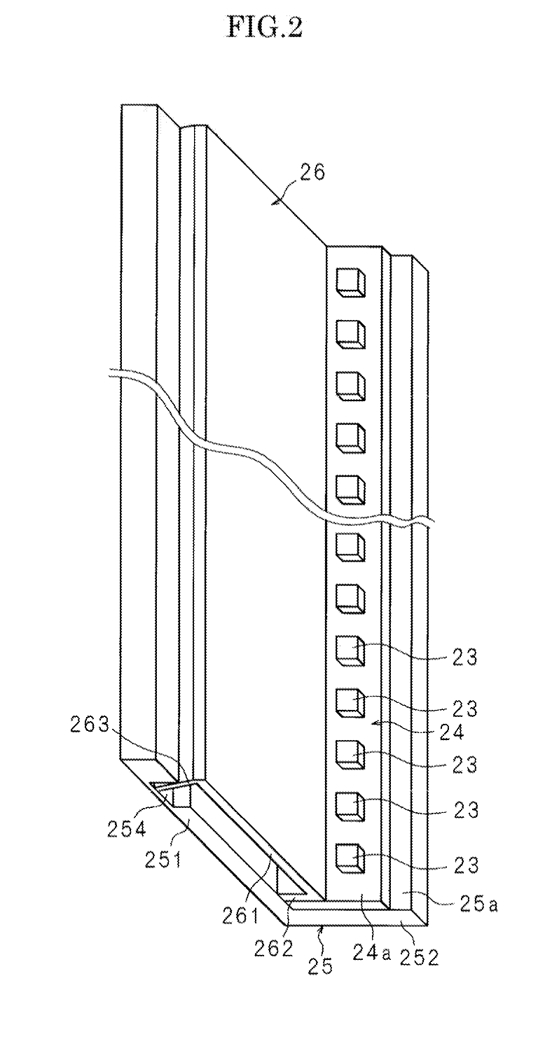

FIG. 2 is a perspective view showing a general structure of the substrate 24, the support member 25 and the heat-insulating member 26.

The light sources 23 shown in FIG. 1 and FIG. 2 are each, for example, an LED.

The substrate 24 has a lengthy shape along a longitudinal direction of the light incident surface 21a. On a mounting surface 24a of the substrate 24, the plurality of light sources 23 are located in series along the longitudinal direction of the light incident surface 21a.

The support member 25 is formed of a metal material having a high thermal conductivity, for example, aluminum.

In the support member 25, a holding portion 252 has a surface 25a in contact with a rear surface, of the substrate 24, opposite to the mounting surface 24a. Along an end of the holding portion 252, a heat dissipation portion (protrusion) 251 is provided along the entire length of the support member 25. The heat dissipation portion 251 protrudes from the surface 25a toward a region facing the facing surface 21a of the light guide body 21, perpendicularly to the surface 25a.

In this specification, the term “entire length” refers to the length between two ends, of a component of interest, in a direction in which the above-mentioned plurality of light sources are located in series (i.e., the longitudinal direction of the light incident surface 21a).

In a surface, of the heat dissipation portion 251, that faces the facing surface 210 of the light guide body 21 (this surface will also be referred to as an “inner surface of the heat dissipation portion 251”), a recessed portion 254 is provided along the entire length of the heat dissipation portion 251. The recessed portion 254 has a rectangular cross-section in a direction perpendicular to the longitudinal direction of the light incident surface 21a, and is provided in the vicinity of an end, of the heat dissipation portion 251, that is farther from the holding portion 252. The inner surface of the heat dissipation portion 251 is continuous from the surface 25a of the holding portion 252.

The substrate 24 is attached to the surface 25a of the holding portion 252 along the entire length of the support member 25. Specifically, the surface 25a of the holding portion 252 and the rear surface opposite to the mounting surface 24a of the substrate 24 are bonded to each other with, for example, a two-sided tape.

The heat-insulating member 26 is formed of a material having a thermal conductivity lower than that of the material used to form the support member 25. A surface of the heat-insulating member 26 has a light-reflective surface in order to reflect heat radiating from the heat dissipation portion 251. The heat-insulating member 26 is formed of, for example, a white synthetic resin. It is preferred that the surface of the heat-insulating member 26 has a light-reflective surface also in order to reflect light that is emitted by the light sources but is not incident on the light incident surface 21a and thus to cause the light to be incident on the light incident surface 21a.

The light-insulating member 26 includes a sheet press 261 having a surface pressing the reflective sheet 22 toward the light guide body 21. At two ends, in a width direction, of the sheet press 261, spacers 262 and 263 are provided to protrude from a rear surface opposite to the above-mentioned surface, perpendicularly to the rear surface along the entire length of the sheet press 261.

In this specification, the term “width direction” refers to a direction perpendicular to the mounting surface 24a of the substrate 24 and the surface 25a of the holding portion 252. A distance along the width direction will be referred to as a “width direction length”.

A thickness of the sheet press 261 in a shorter direction of the light incident surface 21a, and a thickness of the spacer 262 in the width direction, are substantially equal to each other. By contrast, a thickness of the spacer 263 in the width direction is smaller than the thickness of the spacer 262 in the width direction. Therefore, when an external force along the width direction is applied to both of the spacer 262 and the spacer 263 at the same time, the spacer 263 is allowed to be deflected toward the spacer 262, namely, a tip of the spacer 263 is allowed to be made closer to the spacer 262.

The BL chassis 27, which is rectangular dish-like, is formed of a metal material having a high thermal conductivity, for example, iron.

The BL chassis 27 includes a bottom plate 271 having a rectangular outer circumference and four side plates 272 perpendicular to the bottom plate 271. The BL chassis 27 has a structure in which the four side plates 27 are provided along an outer end of the bottom plate 271. Ends, of the side plates 272, farther from the bottom plate 271 define an opening of the BL chassis 27.

The bottom plate 271 is in contact with a rear surface opposite to the inner surface of the heat dissipation portion 251 of the support member 25 supporting the substrate 24 (the rear surface will also be referred to as an “outer surface of the heat dissipation portion 271”), and a recessed accommodation portion 273 is formed in the region of contact along the entire length of the bottom plate 271.

A rear surface, of the holding portion 252, opposite to the surface 25a is continuous from the outer surface of the heat dissipation portion 251, and is in contact with the side plates 272 provided around an outer circumference of the recessed accommodation portion 273.

The support member 25, the heat-insulating member 26, the reflective sheet 22 and the light guide body 21 are accommodated in the BL chassis 27 in this order.

The heat-insulating member 26 is attached to the support member 25 such that the surface, of the sheet press 261, pressing the reflective sheet 22 is directed toward a region of the opening of the BL chassis 27, such that the spacer 262 placed on the inner surface of the heat dissipation portion 251 is in contact with the mounting surface 24a of the substrate 24 along the width direction, and such that the spacer 263 is inserted into the recessed portion 254. A width direction length from the mounting surface 24a to the spacer 263 is longer than a width direction length from the mounting surface 24a to an inner side surface, of the recessed portion 254, farther from the mounting surface 24a. Therefore, the spacer 263 is deflected toward the spacer 262 and thus is inserted into the recessed portion 254. The spacer 263 is put into engagement with the inner side surface, of the recessed portion 254, that is farther from the mounting surface 24a by a restoring force of the spacer 263 deflected toward the spacer 262. The sheet press 261 and the spacer 262 are urged toward the substrate 24 by the restoring force of the spacer 263 deflected toward the spacer 262. As a result, the substrate 24 is held between the spacer 262 and the support member 25. In this manner, the spacer 262 acts as a first contact portion holding the substrate 24 together with the support member 25. The spacer 263 acts as an urging portion urging the spacer 262 toward the substrate 24.

The reflective sheet 22 is accommodated in the BL chassis 27 such that a rear surface, of the reflective sheet 22, opposite to the light-reflective surface is in contact with the bottom plate 271 and the sheet press 261.

The light guide body 21 is accommodated in the BL chassis 27 such that the light guide body 21 is away from the light sources 23 and the substrate 24, such that the light incident surface 21a faces all the light sources 23, and such that the facing surface 210 is in contact with the light-reflective surface of the reflective sheet 22.

As a result of the above, the reflective sheet 22 is held between the light guide body 21 and the bottom surface 27/the sheet press 261. Therefore, the reflective sheet 22 is suppressed from being separated away from the facing surface 210.

The mounting surface 24a of the substrate 24 includes a second region exactly facing the light incident surface 21a of the light guide body 21 and a first region not exactly facing the light incident surface 21a. The spacer 262 of the heat-insulating member 26 is in contact with the first region of the mounting surface 24a.

The frame body 28 has a light-reflective surface in order to reflect light that is emitted by the light sources but is not incident on the light incident surface 21a and thus to cause the light to be incident on the light incident surface 21a. The frame body 28 is formed of, for example, a white synthetic resin. As shown in FIG. 1, the frame body 28, which is rectangular frame-like, has a T-shaped cross-section perpendicular to the longitudinal direction of the light incident surface 21a, and includes two outer frame portions 281 and 282 and an inner frame portion 283.

The outer frame portions 281 and 282 are both rectangular tube-like.

The inner frame portion 283 is rectangular plate-like, and has a rectangular opening formed in a central area thereof. Light propagated through the light guide body 21 is directed toward the display panel 11 via the opening. The inner frame portion 283 protrudes on an inner surface of a rectangular tube formed of the outer frame portions 281 and 282. An end, of the inner frame portion 283, farther from the outer frame portions 281 and 282 defines the opening.

The frame body 28 is attached to the BL chassis 27 such that the outer frame portion 281 is in contact with an outer surface of the side plates 272 of the BL chassis 27 and such that the inner frame portion 283 covers a peripheral area of the light output surface 21b of the light guide body 21.

In this state, a light-blocking cushioning member 29 is held between the inner frame portion 283 and the light guide body 21.

In other words, as a result of the frame body 28 being attached to the BL chassis 27, the light guide body 21 and the reflective sheet 22 are held between the inner frame portion 283 and the bottom plate 271/the sheet press 261 via the cushioning member 29.

Light emitted by the light sources 23 is directed toward the light incident surface 21a of the light guide body 21 directly, or is directed toward the light incident surface 21a after being reflected by a surface of the heat-insulating member 26 or a surface of the frame body 28, and enters into the light guide body 21 via the light incident surface 21a. The light that has entered into the light guide body 21 is propagated in the light guide body 21 while being partially reflected by the light output surface 21b and totally reflected by the facing surface 21a covered with the reflective sheet 22 repeatedly, and is directed outside uniformly via the light output surface 21b.

The surface of the heat-insulating member 26 and the surface of the frame body 28 each have a light-reflective surface. Therefore, the amount of light entering into the light guide body 21 is suppressed from being decreased due to the incidence of the light, emitted by the light sources 23, on the heat-insulating member 26 or the frame body 28.

Neither the surface of the heat-insulating member 26 nor the surface of the frame body 28 needs to be entirely light-reflective. For example, only a region, of the surface of each of the heat-insulating member 26 and the frame body 28, on which light may be incident, may be white. Alternatively, for example, a light-reflective sheet may be bonded to each of the surface of the heat-insulating member 26 and the surface of the frame body 28.

The display apparatus 1 further includes an optical sheet group 12 and a bezel 13.

The optical sheet group 12 includes a plurality of rectangular optical sheets provided in a stacked manner. Each of the optical sheets is light-transmissive, and has a light diffusing function, a light collecting function or the like.

As shown in FIG. 1, the bezel 13 is a rectangular frame-shaped, and has an L-shaped cross-section perpendicular to the longitudinal direction of the light incident surface 21a. The bezel 13 includes a first frame 131 and a second frame 132.

The first frame 131 is rectangular plate-like, and has a rectangular opening formed in a central area thereof. The rectangular opening is defined by an opening end 133.

The second frame 132 is rectangular tube-like, and is provided along an outer end of the first frame 131. Namely, the first frame 131 protrudes inward from the rectangular tube that forms the second frame 132.

The optical sheet group 12, the display panel 11 and the bezel 13 are attached to the backlight unit 2 in this order.

The optical sheet group 12 is attached to the inner frame portion 283 so as to close the opening of the inner frame portion 283. The inner frame portion 283 supports a peripheral area of the optical sheet group 12.

The display panel 11 is attached to the inner frame portion 283 such that the rear surface 11b is in contact with the optical sheet group 12. A light-blocking cushioning member 141 is located between a peripheral area of the rear surface 11b and the inner frame portion 283.

A peripheral edge of the display panel 11 and a peripheral edge of the optical sheet group 12 are surrounded by the outer frame portion 282.

The bezel 13 is attached to the frame body 28 such that the second frame 132 is in contact with an outer surface of the outer frame portion 281 of the frame body 28 and such that the first frame 131 covers a peripheral area of the display screen 11a of the display panel 11.

In this state, a light-blocking cushioning member 142 is held between the first frame 131 and the display panel 11.

In other words, as a result of the frame body 28 being attached to the bezel 13, the display panel 11 is held between the first frame 131 and the inner frame portion 283 via the cushioning members 141 and 142. The display screen 11a is visually recognized via the rectangular opening in the central area of the first frame portion 131.

In the above-described manner, the display apparatus 1 is assembled. The display apparatus 1 is included in, for example, a TV receiver, an electronic signboard, a monitor or the like of a personal computer, or the like.

The display apparatus 1 is supplied with image data. Light directed from the light output surface 21b of the light guide body 21 enters into the display panel 11 after being, for example, diffused and collected by the optical sheet group 12. Liquid crystal molecules in the display panel 11 are supplied with a voltage in accordance with the image data, so that the transmittance of the display screen 11a of the display panel 11 is changed. Therefore, the light that has entered into the display panel 11 is directed outside via the display panel 11 or blocked by the display panel 11. As a result, an image based on the image data is displayed on the display panel 11.

The light sources 23 generate heat along with the light emission.

The substrate 24 is held between the spacer 262 urged by the restoring force of the spacer 263 of the heat-insulating member 26 and the support member 25. As a result, the substrate 24 is pressed onto the support member 25. Therefore, the adherence between the substrate 24 and the support member 25 is improved.

As can be seen, the heat generated by the light sources 23 is conducted efficiently to the heat dissipation portion 251 of the support member 25 via the substrate 24, and is conducted from the heat dissipation portion 251 to the BL chassis 27. The heat conducted to the BL chassis 27 is released to the outside of the display apparatus 1.

The bottom plate 271 of the BL chassis 27 may have an opening formed therein. The heat dissipation portion 251 is exposed outside the BL chassis 27 via the opening. In this case, the heat conducted to the heat dissipation portion 251 is released to the outside of the display apparatus 1 via the opening of the bottom plate 271.

The spacers 262 and 263 provide a space between the heat dissipation portion 251 and the light guide body 21 covered with the reflective sheet 22. In addition, the heat-insulating member 26 has a low thermal conductivity. Therefore, the heat-insulating member 26 suppresses the heat conduction from the heat dissipation portion 251 to the light guide body 21 and the reflective sheet 22. As a result, display unevenness, which would be caused by wrinkles of the reflective sheet 22 caused by the heat conduction to the light guide body 21 and the reflective sheet 22, is suppressed from being caused.

The heat-insulating member 26 has a function of preventing the heat, to be released from the heat dissipation portion 251 to the outside of the apparatus, from returning into the apparatus and a function of holding the light guide body 21 and the reflective sheet 22 between the heat-insulating member 26 and the inner frame portion 283 of the frame body 28. In addition, the heat-insulating member 26 includes the spacers 262 and 263 respectively acting as the first contact portion and the urging portion. Therefore, the number of the components is suppressed from increasing. Since the number of the components is not increased, the backlight unit 2 is easily assembled.

### Embodiment 2

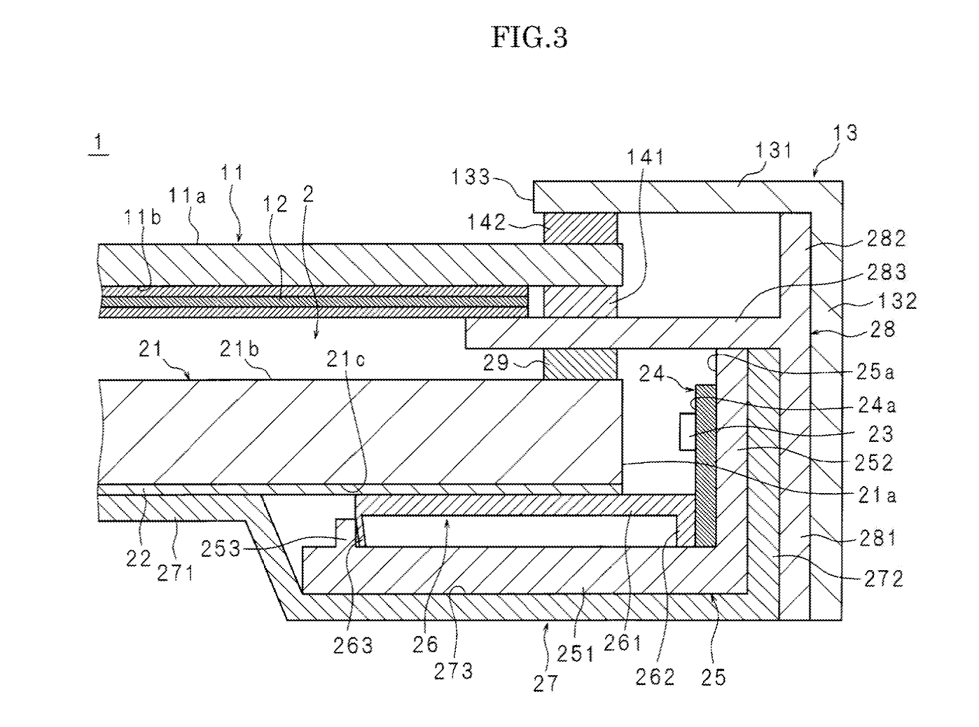

FIG. 3 is a cross-sectional view showing a general structure of a part of a display apparatus 1 including a backlight unit (light source device) in embodiment 2.

The display apparatus 1 in this embodiment has substantially the same structure as that of the display apparatus 1 in embodiment 1. Hereinafter, differences from embodiment 1 will be described. Components corresponding to those in embodiment 1 will bear the same reference signs thereto, and descriptions thereof will be omitted.

A protrusion 253 protrudes on the inner surface of the heat dissipation portion 251, perpendicularly to the inner surface of the heat dissipation portion 251 along the entire length of the heat dissipation portion 251. The protrusion 253, which has a rectangular cross-section perpendicular to the longitudinal direction of the light incident surface 21a, is provided in the vicinity of the end, of the heat dissipation portion 251, that is farther from the holding portion 252.

The heat-insulating member 26 is attached to the support member 25 such that the surface, of the sheet press 261, pressing the reflective sheet 22 is directed toward the region of the opening of the BL chassis 27, such that the spacer 262 placed on the inner surface of the heat dissipation portion 251 is in contact with the first region of the mounting surface 24a of the substrate 24 along the width direction, and such that the spacer 263 is in contact with a side surface, of the protrusion 253, that is closer to the mounting surface 24a. A width direction length from the mounting surface 24a to the spacer 263 is longer than a width direction length from the mounting surface 24a to the side surface, of the protrusion 253, that is closer to the mounting surface 24a. Therefore, the spacer 263 is deflected toward the spacer 262. The spacer 263 is put into engagement with the side surface, of the protrusion 253, that is closer to the mounting surface 24a by a restoring force of the spacer 263 deflected toward the spacer 262. The sheet press 261 and the spacer 262 are urged toward the substrate 24 by the restoring force of the spacer 263 deflected toward the spacer 262. As a result, the substrate 24 is held between the spacer 262 and the support member 25. In this manner, the spacer 262 acts as a first contact portion holding the substrate 24 together with the support member 25. The spacer 263 acts as an urging portion urging the spacer 262 toward the substrate 24.

### Embodiment 3

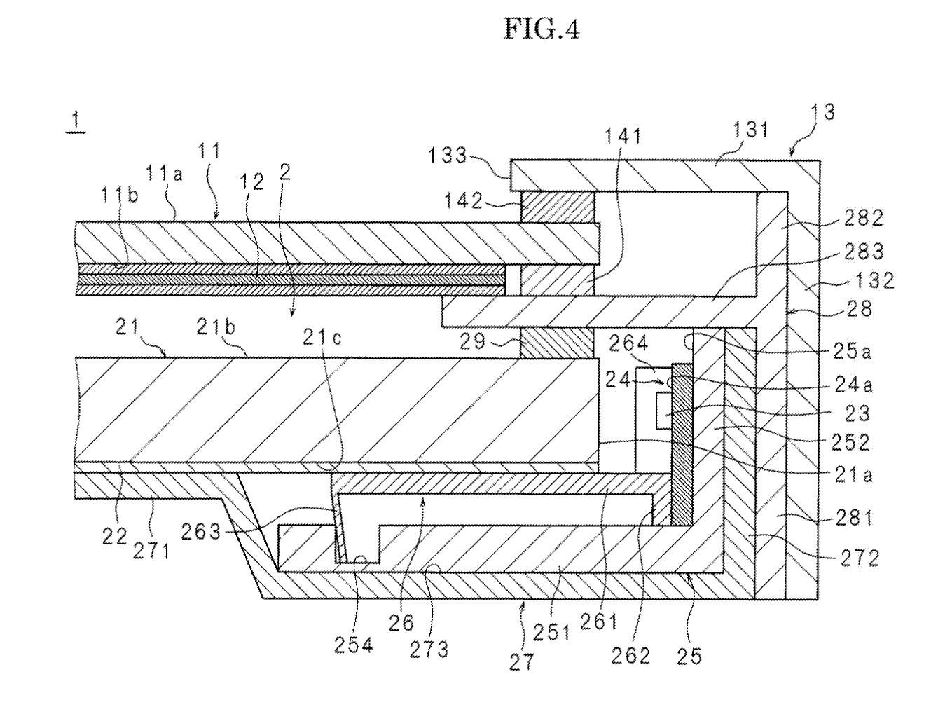

FIG. 4 is a cross-sectional view showing a general structure of a part of a display apparatus 1 including a backlight unit (light source device) in embodiment 3.

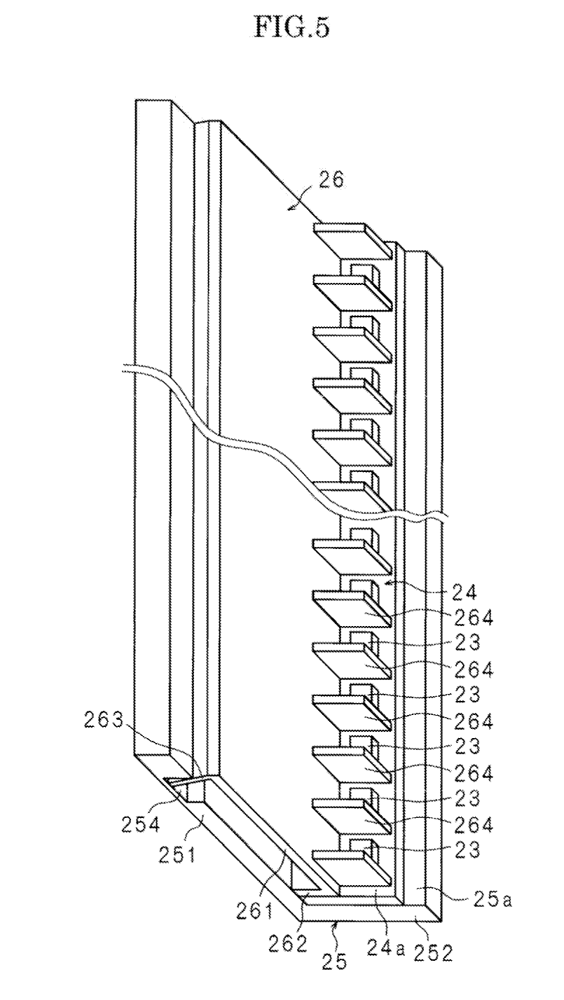

FIG. 5 is a perspective view showing a general structure of the substrate 24, the support member 25 and the heat-insulating member 26 included in the backlight unit 2.

The display apparatus 1 in this embodiment has substantially the same structure as that of the display apparatus 1 in embodiment 1. Hereinafter, differences from embodiment 1 will be described. Components corresponding to those in embodiment 1 will bear the same reference signs thereto, and descriptions thereof will be omitted.

The heat-insulting member 26 includes a plurality of ribs 264 on the surface, of the sheet press 261, pressing the reflective sheet 22.

The ribs 264 each protrude on the surface, of the sheet press 261, that is opposite to the spacer 262, in a direction opposite to the spacer 262. The ribs 264 are rectangular plate-like. One end surface, in the width direction, of each rib 264 is flush with the surface, of the spacer 262, that is in contact with the substrate 24. The ribs 264 are provided in series in the longitudinal direction of the light incident surface 21a.

The ribs 264 and the light sources 23 are located alternately, so that one rib 264 is provided to each of two sides of each light source 23, in the longitudinal direction of the light incident surface 21a. The above-mentioned end surface of the rib 264 is in contact with a region, of the second region of the mounting surface 24a, on which no light source 23 is mounted. Namely, the ribs 264 each act as a second contact portion.

A width direction length from the mounting surface 24a to the ribs 264 is longer than a width direction length from the mounting surface 24 to the light sources 23. Therefore, the distance from the light incident surface 21a of the light guide body 21 to the ribs 264 is shorter than the distance from the light incident surface 21a to the light sources 23. For this reason, even if the light incident surface 21a is made closer to the light sources 23 due to, for example, thermal expansion of the light guide body 21, there is no possibility that the light incident surface 21a contacts the light sources 23. A reason for this is that the light incident surface 21a made closer to the light sources 23 contacts the ribs 264.

It is preferred that a length of the ribs 264 along a shorter direction of the light incident surface 21a is substantially equal to a length between two ends of the second region in such a direction. With such a structure, the substrate 24 is pressed onto the support member 25 in the entirety of the second region along the shorter direction of the light incident surface 21a.

The sheet press 261, the spacer 262 and the ribs 264 are urged toward the substrate 24 by a restoring force of the spacer 263 deflected toward the spacer 262. As a result, the substrate 24 is held between the spacer 262/the ribs 264 and the support member 25. Thus, a larger area of the substrate 24 is pressed onto the support member 25. Therefore, the adherence between the substrate 24 and the support member 25 is further improved.

The spacer 263 in each of embodiments 1 through 3 is engaged with the recessed portion or the protrusion provided in or on the heat dissipation portion 251. The spacer 263 is not limited to this. The spacer 263 may be engaged with, for example, a recessed portion or a protrusion provided in the BL chassis 27.

### Embodiment 4

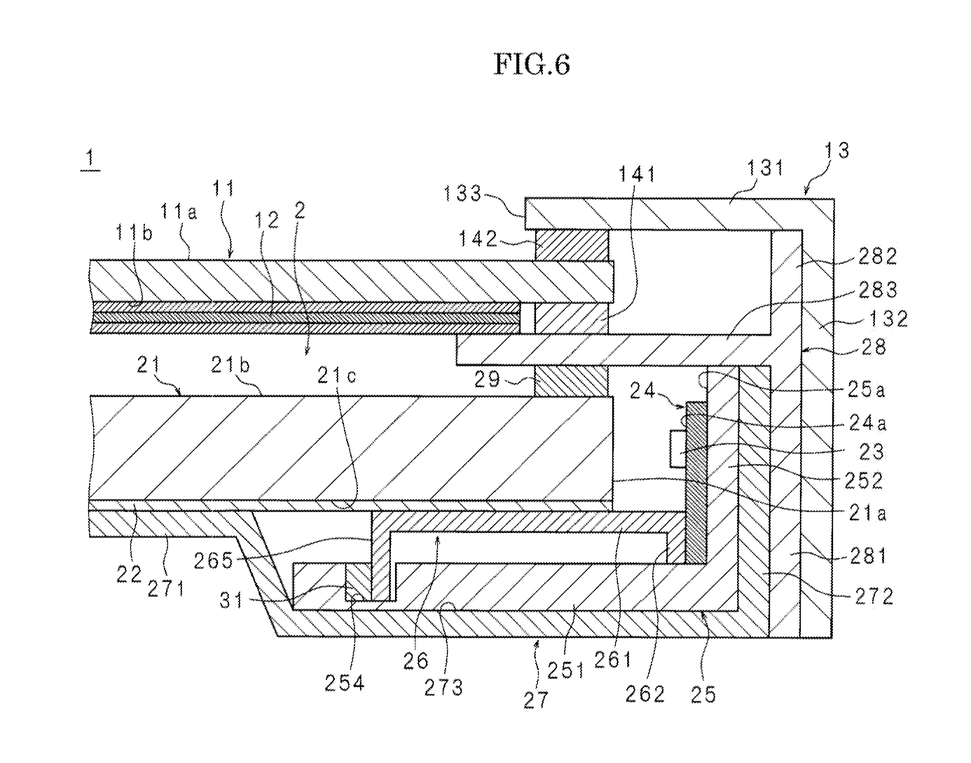

FIG. 6 is a cross-sectional view showing a general structure of a part of a display apparatus 1 including a backlight unit (light source device) in embodiment 4.

The display apparatus 1 in this embodiment has substantially the same structure as that of the display apparatus 1 in embodiment 1. Hereinafter, differences from embodiment 1 will be described. Components corresponding to those in embodiment 1 will bear the same reference signs thereto, and descriptions thereof will be omitted.

The spacer 262 and a spacer 265 are provided at both of the two ends, in the width direction, of the sheet press 261 of the heat-insulating member 26. The spacers 262 and 265 protrude from the rear surface opposite to the surface pressing the reflective sheet 22 toward the light guide body 21, perpendicularly to the rear surface along the entire length of the sheet press 261. The spacer 265 is located at the same position as that of the spacer 263 in embodiment 1, but a thickness of the spacer 265 in the width direction is approximately equal to the thickness of the spacer 262 in the width direction.

The heat-insulating member 26 is attached to the support member 25 such that the surface, of the sheet press 261, pressing the reflective sheet 22 is directed toward the region of the opening of the BL chassis 27, such that the spacer 262 placed on the inner surface of the heat dissipation portion 251 is in contact with the first region of the mounting surface 24a of the substrate 24 along the width direction, and such that the spacer 265 is inserted into the recessed portion 254. A width direction length from the mounting surface 24a to the spacer 265 is longer than a width direction length from the mounting surface 24a to an inner side surface, of the recessed portion 254, that is closer to the mounting surface 24a, and is shorter than a width direction length from the mounting surface 24a to the inner side surface, of the recessed portion 254, that is farther from the mounting surface 24a.

An urging member 31 is fitted to the inner side surface, of the recessed portion 254, that is farther from the mounting surface 24a. The urging member 31 is a rod member having a rectangular cross-section perpendicular to the longitudinal direction of the light incident surface 21a. The urging member 31 is an elastic member, for example, a cushioning member formed of a synthetic resin.

The urging member 31 is compressed between the spacer 265 and the inner side surface, of the recessed portion 254, that is farther from the mounting surface 24a. The spacer 265 is urged toward the substrate 24 by a restoring force of the compressed urged member 31. As a result, the sheet press 261 and the spacer 262 are urged toward the substrate 24, and thus the substrate 24 is held between the spacer 262 and the support member 25.

### Embodiment 5

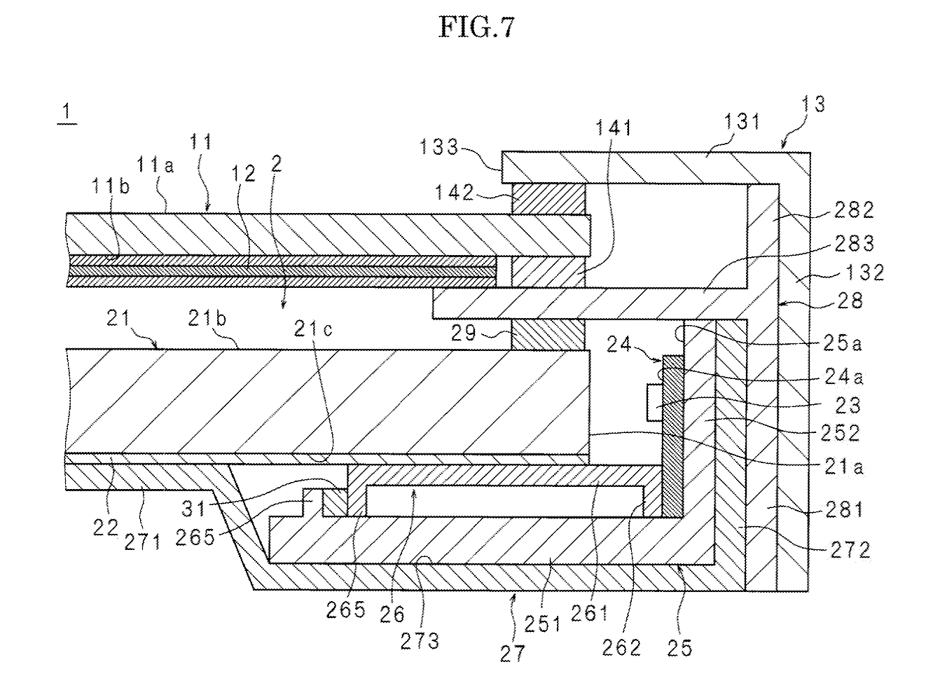

FIG. 7 is a cross-sectional view showing a general structure of a part of a display apparatus 1 including a backlight unit (light source device) in embodiment 5.

The display apparatus 1 in this embodiment has substantially the same structure as that of the display apparatus 1 in embodiment 4. Hereinafter, differences from embodiment 4 will be described. Components corresponding to those in embodiment 4 will bear the same reference signs thereto, and descriptions thereof will be omitted.

The protrusion 253 substantially the same as in embodiment 2 protrudes on the heat dissipation portion 251.

A width direction length from the mounting surface 24a to the spacer 265 is shorter than a width direction length from the mounting surface 24a to the side surface, of the protrusion 253, that is closer to the mounting surface 24a.

The heat-insulating member 26 is attached to the support member 25 such that the surface, of the sheet press 261, pressing the reflective sheet 22 is directed toward the region of the opening of the BL chassis 27, such that the spacer 262 placed on the inner surface of the heat dissipation portion 251 is in contact with the first region of the mounting surface 24a of the substrate 24 along the width direction, and such that the urging member 31 is located between the spacer 265 and the side surface, of the protrusion 253, that is closer to mounting surface 24a.

The urging member 31 is compressed between the spacer 265 and the side surface, of the protrusion 253, that is closer to mounting surface 24a. The spacer 265 is urged toward the substrate 24 by a restoring force of the compressed urging member 31. As a result, the sheet press 261 and the spacer 262 are urged toward the substrate 24, and thus the substrate 24 is held between the spacer 262 and the support member 25.

In this embodiment, the heat-insulating member 26 in each of embodiments 4 and 5 may include the ribs 264 in embodiment 3.

The spacer 265 in each of embodiments 4 and 5 is engaged with the recessed portion or the protrusion provided in or on the heat dissipation portion 251 via the urging member 31. The spacer 265 is not limited to this. The spacer 265 may be engaged with, for example, a recessed portion or a protrusion provided in the BL chassis 27 via the urging member 31.

The urging member 31 is not limited to being a cushioning member formed of a synthetic resin, and may be, for example, a synthetic rubber member or a spring member. The urging member 31 may have a light-reflecting surface.

### Embodiment 6

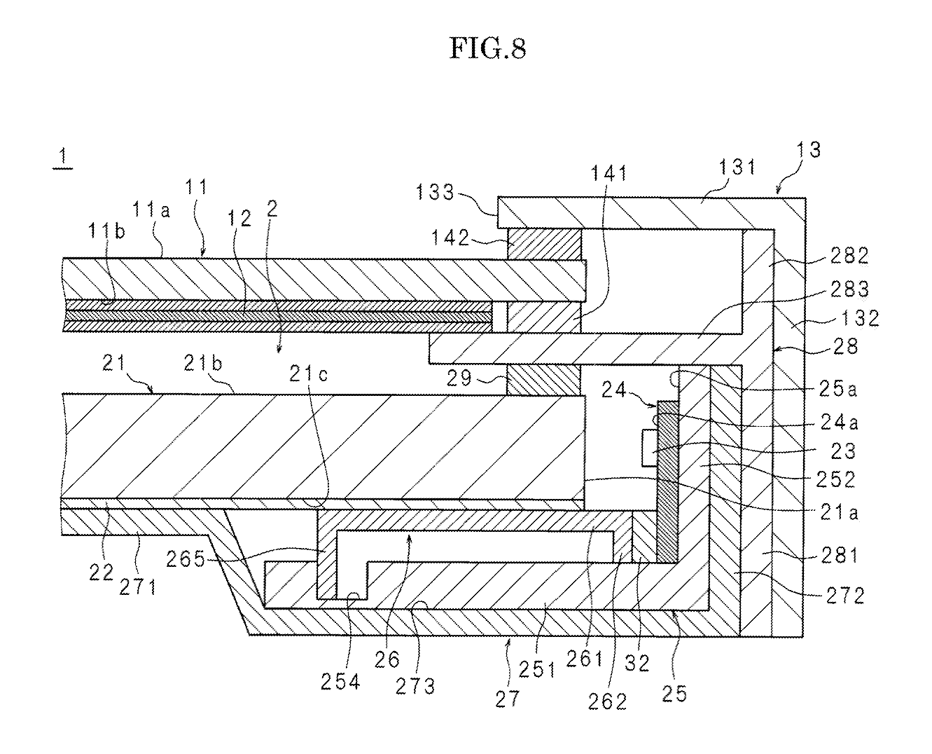

FIG. 8 is a cross-sectional view showing a general structure of a part of a display apparatus 1 including a backlight unit (light source device) in embodiment 6.

The display apparatus 1 in this embodiment has substantially the same structure as that of the display apparatus 1 in embodiment 4. Hereinafter, differences from embodiment 4 will be described. Components corresponding to those in embodiment 4 will bear the same reference signs thereto, and descriptions thereof will be omitted.

The heat-insulating member 26 is attached to the support member 25 such that the surface, of the sheet press 261, pressing the reflective sheet 22 is directed toward the region of the opening of the BL chassis 27, such that an interjacent member 32 is provided between the spacer 262 placed on the inner surface of the heat dissipation portion 251 and the first region of the mounting surface 24a of the substrate 24, and such that the spacer 265 is inserted into the recessed portion 254 and is in contact with the inner side surface, of the recessed portion 254, farther from the mounting surface 24a.

The interjacent member 32 is a rod member having a rectangular cross-section perpendicular to the longitudinal direction of the light incident surface 21a. The interjacent member 32 is an elastic member, for example, a cushioning member formed of a synthetic resin.

The interjacent member 32 is compressed between the spacer 262 and the first region of the mounting surface 24a of the substrate 24. The sheet press 261 and the spacer 262 are urged toward the substrate 24 by a restoring force of the compressed interjacent member 32. As a result, the substrate 24 is held between the spacer 262 and the support member 25.

### Embodiment 7

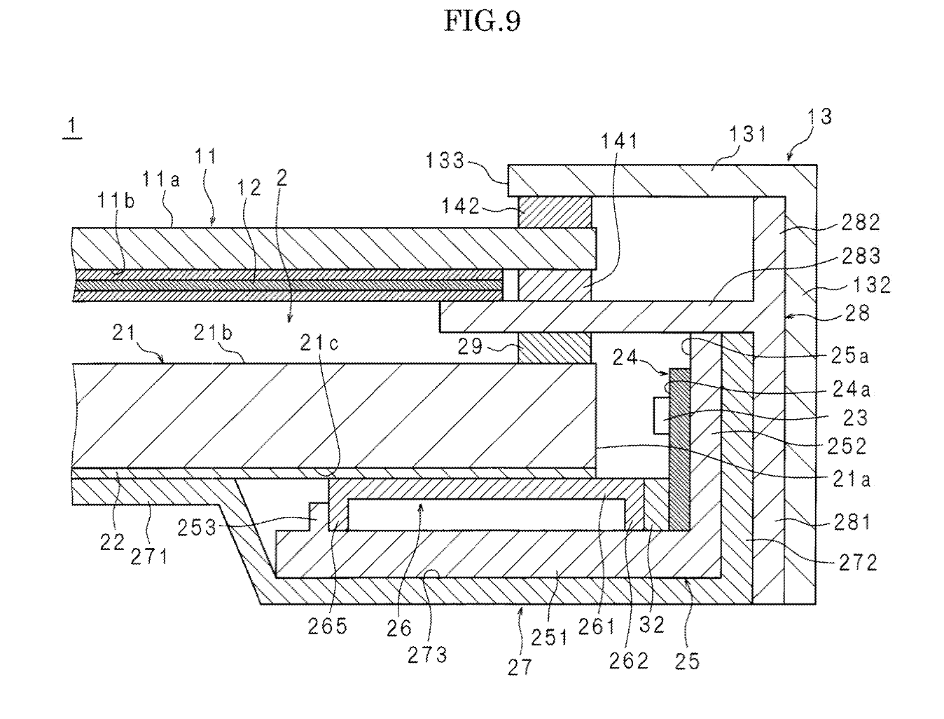

FIG. 9 is a cross-sectional view showing a general structure of a part of a display apparatus 1 including a backlight unit (light source device) in embodiment 7.

The display apparatus 1 in this embodiment has substantially the same structure as that of the display apparatus 1 in embodiment 6. Hereinafter, differences from embodiment 6 will be described. Components corresponding to those in embodiment 6 will bear the same reference signs thereto, and descriptions thereof will be omitted.

The protrusion 253 substantially the same as in embodiment 2 protrudes on the heat dissipation portion 251.

The heat-insulating member 26 is attached to the support member 25 such that the surface, of the sheet press 261, pressing the reflective sheet 22 is directed toward the region of the opening of the BL chassis 27, such that the interjacent member 32 is provided between the spacer 262 placed on the inner surface of the heat dissipation portion 251 and the first region of the mounting surface 24a of the substrate 24, and such that the spacer 265 is in contact with the side surface, of the protrusion 253, closer to the mounting surface 24a.

The interjacent member 32 is compressed between the spacer 262 and the first region of the mounting surface 24a of the substrate 24. The sheet press 261 and the spacer 262 are urged toward the substrate 24 by a restoring force of the compressed interjacent member 32, and thus the substrate 24 is held between the spacer 262 and the support member 25.

The spacer 265 in each of embodiments 6 and 7 is engaged with the recessed portion or the protrusion provided in or on the heat dissipation portion 251. The spacer 265 is not limited to this. The spacer 265 may be engaged with, for example, a recessed portion or a protrusion provided in the BL chassis 27.

The interjacent member 32 is compressed between the spacer 262 and the first region of the mounting surface 24a of the substrate 24. The interjacent member 32 is not limited to this. For example, a support protrusion that supports the spacer 262 at a position between the spacer 262 and the substrate 24 may protrude on the heat dissipation portion 251, and the interjacent member 32 may be compressed between the support protrusion of the heat dissipation portion 251 and the first region of the mounting surface 24a of the substrate 24.

The interjacent member 32 is not limited to being a cushioning member formed of a synthetic resin, and may be, for example, a synthetic rubber member or a spring member. The interjacent member 32 may have a light-reflecting surface.

In embodiments 1 through 7, a structure in which the backlight unit 2 includes a set of the substrate 24 and the support member 25 corresponding to a single light incident surface of the light guide body 2 is described as an example. The structure of the backlight unit 2 is not limited to this. For example, the backlight unit 2 may include a set of the substrate 24 and the support member 25 corresponding to each of two light incident surfaces, facing each other, of the light guide body 21.

The light guide body 21 is not limited to being plate-like, and may be, for example, cuboid.

The substrate 24 may be attached to the support member 25 by a spring or a rivet. Even in the case where the screw or the rivet is loosened due to defective screwing or riveting or due to aging, the substrate 24 held as described above is pressed onto the support member 25. Therefore, the adherence between the substrate 24 and the support member 25 is improved.

The light source device in the embodiments is not limited to being the backlight unit 2 incorporated into the display apparatus 1, and may be, for example, provided in an illumination device such as a ceiling light, a wall light or the like. In such a case also, an effect of suppressing a temperature rise in the vicinity of the light source is provided.

Namely, the essence of the present invention is in the structure of the light source device, and the effect of the present invention is not lost even in an independent light source device not included in a display apparatus.

Now, a summary of embodiments 1 through 7 will be provided.

In an embodiment, in the case where the substrate is held between the first contact portion of the heat-insulating member and the support member, the substrate is pressed onto the support member. Therefore, the adherence between the substrate and the support member is improved. For this reason, heat generated by the light source is released efficiently to the outside of the apparatus from the heat dissipation portion of the support member via the substrate.

In an embodiment, in the case where the substrate is held between the first contact portion/the second portion of the heat-insulating member and the support member, a larger area of the substrate is pressed onto the support member. Therefore, the adherence between the substrate and the support member is improved.

In an embodiment, even if, for example, the light incident surface of the light guide body is made closer to the light source by thermal expansion of the light guide body, there is no possibility that the light incident surface contacts the light source. A reason for this is that the light incident surface made closer to the light source contacts the second contact portion.

In an embodiment, the substrate may be held between the first contact portion, of the heat-insulating member, urged by a restoring force of the urging portion of the heat-insulating member and the support member.

In an embodiment, the substrate may be held between the first contact portion, of the heat-insulating member, urged by a restoring force of the urging member and the support member.

In an embodiment, light is reflected by the light-reflective surface of the heat-insulating member. Therefore, the amount of light incident on the light guide body is suppressed from being decreased due to the entrance of the light, emitted by the light source, into the heat-insulating member.

In an embodiment, the substrate is held between the interjacent member and the support member. As a result, the substrate is pressed onto the support member. Therefore, the adherence between the substrate and the support member is improved. For this reason, the heat generated by the light source is released efficiently to the outside of the apparatus from the heat dissipation portion of the support member via the substrate.

In an embodiment, the substrate may be held between the interjacent member and the support member by a restoring force of the interjacent member.

The embodiments disclosed herein are illustrative in all the aspects and are not to be construed as limiting the present invention. The scope of the present invention is not intended to be limited by the above-described significance but is intended to encompass all the significance equivalent to the claims and all the modifications within the scope of the claims.

As long as the effect of the present invention is provided, the display apparatus 1 or the backlight unit 2 may include components that are not disclosed in any of embodiments 1 through 7.

The elements (technological features) disclosed in each of the embodiments may be combined, and a novel technological feature may be provided by such a combination.

### REFERENCE SIGNS LIST

1 display apparatus
11 display panel
2 backlight unit (light source device)
21 light guide body
21a light incident surface
21b light output surface
210 facing surface
23 light source
24 substrate
24a mounting surface
25 support member
251 light dissipation portion (protrusion)
252 holding portion
26 heat-insulating member
262 spacer (first contact portion)
263 spacer (urging portion)
264 rib (second contact portion)
31 urging member
32 interjacent member

1. A light source device, comprising:
a substrate having a mounting surface on which a light source is mounted;
a light guide body having a light incident surface via which light directed from the light source enters into the light guide body, a light output surface, via which the light that has entered into the light guide body via the light incident surface, is directed outside, and a facing surface facing the light output surface; and
a support member supporting the substrate such that the light directed from the light source enters into the light guide body via the light incident surface,
wherein the mounting surface includes a first region not exactly facing the light incident surface and a second region exactly facing the light incident surface,
wherein the support member has a surface in contact with a rear surface opposite to the mounting surface, and includes a holding portion holding the substrate and a protrusion protruding from the holding portion toward a region facing the facing surface,
wherein a heat-insulating member is provided between the protrusion and the light guide body, and
wherein the heat-insulating member includes a first contact portion in contact with the first region.

2. The light source device of claim 1, wherein the heat-insulating member includes a second contact portion in contact with a region, of the second region, on which the light source is not mounted.

3. The light source device of claim 2, wherein a length from the mounting surface to the second contact portion is longer than a length from the mounting surface to the light source.

4. The light source device of claim 1, wherein the heat-insulating member includes an urging portion urging the first contact portion toward the substrate.

5. The light source device of claim 1, further comprising an urging member urging the first contact portion toward the substrate.

6. The light source device of claim 1, wherein the heat-insulating member has a light-reflective surface.

7. A light source device, comprising:
a substrate having a mounting surface on which a light source is mounted;
a light guide body having a light incident surface via which light directed from the light source enters into the light guide body, a light output surface, via which the light that has entered into the light guide body via the light incident surface, is directed outside, and a facing surface facing the light output surface; and
a support member supporting the substrate such that the light directed from the light source enters into the light guide body via the light incident surface,
wherein the mounting surface includes a first region not exactly facing the light incident surface and a second region exactly facing the light incident surface,
wherein the support member has a surface in contact with a rear surface opposite to the mounting surface, and includes a holding portion holding the substrate and a protrusion protruding from the holding portion toward a region facing the facing surface,
wherein a heat-insulating member is provided between the protrusion and the light guide body, and
wherein the light source device further includes an interjacent member located between the heat-insulating member and the first region, the interjacent member holding the substrate in a state where the substrate is located between the interjacent member and the support member.

8. The light source device of claim 7, wherein the interjacent member is elastic.

9. A display apparatus, comprising:
a light source device; and
a display panel illuminated by the light source device,
wherein the light source comprising:
a substrate having a mounting surface on which a light source is mounted;
a light guide body having a light incident surface via which light directed from the light source enters into the light guide body, a light output surface, via which the light that has entered into the light guide body via the light incident surface, is directed outside, and a facing surface facing the light output surface; and
a support member supporting the substrate such that the light directed from the light source enters into the light guide body via the light incident surface,
wherein the mounting surface includes a first region not exactly facing the light incident surface and a second region exactly facing the light incident surface,
wherein the support member has a surface in contact with a rear surface opposite to the mounting surface, and includes a holding portion holding the substrate and a protrusion protruding from the holding portion toward a region facing the facing surface,
wherein a heat-insulating member is provided between the protrusion and the light guide body, and
wherein the heat-insulating member includes a first contact portion in contact with the first region.

10. The display apparatus of claim 9, wherein the heat-insulating member includes a second contact portion in contact with a region, of the second region, on which the light source is not mounted.

11. The display apparatus of claim 10, wherein a length from the mounting surface to the second contact portion is longer than a length from the mounting surface to the light source.

12. The display apparatus of claim 9, wherein the heat-insulating member includes an urging portion urging the first contact portion toward the substrate.

13. The display apparatus of claim 9, further comprising an urging member urging the first contact portion toward the substrate.

14. The display apparatus of claim 9, wherein the heat-insulating member has a light-reflective surface.

15. A display apparatus, comprising:
a light source device; and
a display panel illuminated by the light source device,
wherein the light source comprising:
a substrate having a mounting surface on which a light source is mounted;
a light guide body having a light incident surface via which light directed from the light source enters into the light guide body, a light output surface, via which the light that has entered into the light guide body via the light incident surface, is directed outside, and a facing surface facing the light output surface; and
a support member supporting the substrate such that the light directed from the light source enters into the light guide body via the light incident surface,
wherein the mounting surface includes a first region not exactly facing the light incident surface and a second region exactly facing the light incident surface,
wherein the support member has a surface in contact with a rear surface opposite to the mounting surface, and includes a holding portion holding the substrate and a protrusion protruding from the holding portion toward a region facing the facing surface,
wherein a heat-insulating member is provided between the protrusion and the light guide body, and
wherein the light source device further includes an interjacent member located between the heat-insulating member and the first region, the interjacent member holding the substrate in a state where the substrate is located between the interjacent member and the support member.

16. The display apparatus of claim 15, wherein the interjacent member is elastic.
